(19) United States
(12) Patent Application Publication
(10) Pub. No.: US 2005/0067106 A1
(43) Pub. Date: Mar. 31, 2005

(54) Food labeling device for printing time and date information on adhesive labels to track freshness

(76) Inventor: Suzanne K. Melges, Lake Forest, IL (US)

Correspondence Address: LAW OFFICE OF BRIAN R. RAYVE, P.O. Box 11586, Salt Lake City, UT, 84147-0586, US

(21) Appl. No.: 10/672,016

(22) Filed: Sep. 25, 2003

(51) Int. Cl. B32B 31/00; B32B 1/00; B41M 1/00

(52) U.S. Cl. 156/367; 156/384; 156/579

(57) ABSTRACT

A food labeling device for printing the current time and date or a future expiration date on adhesive labels carried on a backing strip. The labels are attached to non-refrigerated, refrigerated, and frozen foods to track freshness. The labeling device includes a housing which magnetically mounts to the door of a refrigerator/freezer in which a roll of the labels carried on the backing strip. A controller within the housing tracks the time/date information. A pair of set switches are provided for allowing a user to set the time/date information. A liquid crystal display mounted to the housing displays the time/date information for the user to view. Pushing an actuator switch initiates label printing by a printing head to imprint the time/date information on the labels passing thereby advanced in coordinated manner by a motor and gear arrangement connected to a platen closely adjacent the print head. The label strip passes outwardly from the housing through a label outlet slot. A battery contained within the housing powers the display, the stepping motor, and the printing head. The housing includes a pair of magnets affixed to a rear portion of the housing for magnetically mounting the food labeling device to the refrigerator/freezer door.

### BACKGROUND OF THE INVENTION

1. Field

The invention relates generally to label printing devices for printing on pressure sensitive labels releasibly carried on a backing strip, and more particularly to portable thermal label printing devices which are of small size such as for holding in-hand powered by batteries.

2. State of the Art

Modern food products come in a variety of forms including fresh, frozen, and freeze-dried. A major factor in the tastiness of prepared foods is the freshness of the food products or ingredients. Many such food products require refrigeration or must be maintained in a frozen condition to best preserve freshness. However, refrigerated food products gradually lose freshness over time and are no longer useable after periods of time ranging from a few days to several weeks. Likewise, even frozen food products become unuseable, though typically over longer periods of time ranging from weeks to months. For example, ice cream and sherbet gradually separate into their component parts and are unuseable after a period of time from about two to three months. Meats packaged in shrink wrap plastic film lose moisture and become freezer burned after a period of time from about one to two months. While some food products have expiration dates printed on their packaging, many do not, or the expiration date is not readily visible. Therefore, it would be desirable to have a label printing device for printing adhesive labels with the current time/date information and/or an expiration date based on the probable shelf life thereof so freshness can be monitored better. This would allow old food products to be consumed prior to the expiration date so freshness is maximized or disposed of when the expiration date has passed. It would also be desirable for the label printing device to be compact, have a built-in electrical power source, and be removably mountable on the refrigerator/freezer unit in which the food products are stored.

Various portable mechanical label printing devices have been designed and used over the years for various purposes. For example, such label printing devices have been used in retail stores to print and apply price labels to various products. Such label printing devices of the mechanical type are disclosed in U.S. Pat. Nos. 4,498,950 issued to Sato et al.; 5,655,450 issued to Hermannn; and 6,170,395 issued to Lee. These label printers typically utilize a rolled label strip comprised of pressure sensitive labels carried on a backing strip of supporting material. The label roll is mounted to a housing having a handle for holding in-hand and a movable handle pivotally connected thereto. An advancement mechanism is provided for advancing the label strip upon squeezing together of the handles. A printing head is mounted to the housing which includes a plurality of print bands mounted on respective upper and lower drive shafts each having a plurality of printable characters. A longitudinally and rotationally movable selector shaft allows a user to move the print bands about the drive shafts to select the characters on the print bands to print. The printing head is moved toward the label to bring the selected characters into contact therewith upon squeezing together of the handles. An inking roller and mechanism is provided which inks the selected characters prior to contact with the labels.

With the advent of modern electronics including computers, various portable, electronic label printing devices have been designed to utilize the electronic printing and data memory advantages of electronics. For example, label printing devices have been used in retail stores to print and apply bar code labels to products and to enter data into a computer database. Such label printing devices of the electronic type are disclosed in U.S. Pat. Nos. 4,706,095 issued to Ono et al.; 4,746,932 issued to Sato; and 4,871,269 issued to Murata. These label printers typically utilize a rolled label strip comprised of pressure sensitive, thermal imprintable labels carried on a backing strip of supporting material. The label roll is mounted to a housing designed to be held in-hand. An electronic advancement mechanism is provided including a motor and pulley arrangement which drive a cylindrical platen and a plurality of rollers for advancing the label strip upon actuation of a switch. A thermal printing head is mounted to the housing closely opposite the platen between which the label strip passes for thermal imprinting. A power supply for the motor and printing head is either contained within the housing or contained in a separate self-contained power supply unit with a connecting cable that plugs into a socket of the housing. The power supply unit is stored in the user's pocket or attached to the user's waist. A pen scanner may be used with a connecting cable that plugs into a socket of the housing. The pen scanner inputs data from bar codes on the products into a control circuit with memory within the label printing device that is used to control the reading and printing functions. The control circuit stores and downloads the bar code data to a computer database such as for inventory purposes.

While the prior art label printing devices are suitable for the purposes for which they were intended, they do not print the current time/date information or an expiration date on the labels. Additionally, they are not as compact as desired, some do not have a built-in electrical power source, and they are not removably mountable on the refrigerator/freezer unit in which the food products are stored.

Therefore, there is a need for a label printing device for printing adhesive labels with the current time/date information and/or an expiration date based on the probable shelf life thereof so freshness can be monitored better. The label printing device would be compact, have a built-in electrical power source, and be removably mountable to the refrigerator/freezer unit in which the food products are stored.

### SUMMARY OF THE INVENTION

The present invention is a food labeling device powerable by an electrical source for printing time/date information on a label strip. The label strip has an adhesive backing for attachment to food items which is removably adhered to a backing strip. The label strip is formed as a label roll. The food labeling device includes a housing adapted for receiving the label roll. A controller is associated with the housing adapted for computing and outputting the time/date information in the form of control signals upon receipt of a request therefor. At least one input device is associated with the housing adapted for a user to operate the controller including setting the time/date information and for submitting the request therefor. A display device is associated with the housing adapted for receiving the control signals from the controller and displaying the time/date information for the user to view. A printing device is associated with the housing adapted for receiving the control signals from the controller and imprinting the time/date information on the label strip passing thereby from the label roll. A transport device is associated with the housing adapted for receiving the control signals from the controller and advancing the label strip. The advancing of the label strip is done in a coordinated manner with printing of the time/date information by the printing device on the label strip. The controller, the input device, the display device, the printing device, and the transport device are powered by the electrical source.

In first preferred embodiment of the food labeling device the input devices include an actuator switch to initiate label printing and at least one time/date set switch for setting the time/date information of the controller. The housing is of such size as to be held in-hand and defines an interior chamber in which the controller, the electrical source, each input device, the display device, the printing device, and the transport device are disposed. The display device is viewable through a display hole through the housing. Each input device is accessible by the user through respective input device holes through the housing. The label strip is passable outwardly from within the housing through a label outlet slot through the housing. The housing includes a battery compartment within the interior chamber into which the electrical source in the form of a portable electrical storage device is removably insertable. The housing includes at least one mounting device affixed to a rear portion of the housing adapted for mounting the food labeling device to a mounting surface. The display device comprises a liquid crystal display. The housing is adapted to receive the label roll within the interior chamber. The printing device comprises a thermal printing device for printing on thermal printable label strips. A rear portion of the housing includes a label roll receiving hole sized for insertion of the label roll into the interior chamber. The housing has a label roll support adapted for positioning and rotatably supporting the label roll within the interior chamber. The label roll support includes at least one resiliently flexible arm which extends inwardly into the label roll receiving hole from the rear portion of the housing terminating at a central disk with a centering post which extends forwardly therefrom to fit within a tubular core of the label roll. The food labeling device includes a position sensor adapted to sense positioning of the label strip by detecting a plurality of markers on the label strip disposed at substantially equally spaced positions for determining position of the individual labels relative to the printing device. The controller is adapted for printing label strips comprised of a plurality of individual labels with adhesive backing which are removably adhered in a linear spaced manner to the backing strip. The position sensor is adapted to detect markers of a type such as perforations and printed indicia.

In a second preferred embodiment of the food labeling device the input devices include an actuator switch to initiate label printing and at least one time/date set switch for setting the time/date information of the controller. The printing device includes a support frame adapted to receive the label strip therethrough, a printing head fixedly mounted to the support frame, and a cylindrical roller rotationally mounted to the support frame closely adjacent the thermal printing head to frictionally engage the label strip. The transport device includes a drive motor comprising an electric stepping motor mounted to the support frame and operably connected to the roller platen adapted to receive the control signals from the controller and rotate the roller in the coordinated manner with the thermal printing head. The printing device comprises a thermal printing device for printing on thermal printable label strips. The drive motor is operably connected to the platen through a plurality of gears. The drive motor includes a gear box driven by the stepping motor which drives the gears. The controller is adapted for printing label strips comprised of a plurality of individual labels with adhesive backing which are removably adhered in a linear spaced manner to the backing strip. The position sensor is adapted to detect markers of a type such as perforations and printed indicia.

### THE DRAWINGS

The best mode presently contemplated for carrying out the invention is illustrated in the accompanying drawings, in which:

FIG. 1 is a perspective view of a food labeling device in accordance with the present invention;

FIG. 2, a front elevational view of the food labeling device taken on the line 2-2 of FIG. 1;

FIG. 3, a rear elevational view of the food labeling device taken on the line 3-3 of FIG. 1;

FIG. 4, a perspective view of the food labeling device;

FIG. 5, a top plan view of the food labeling device taken on the line 5-5 of FIG. 2;

FIG. 6, a side elevational view of the food labeling device taken on the line 6-6 of FIG. 2;

FIG. 7, an exploded perspective view of the food labeling device;

FIG. 8, a rear elevational view of a front housing half of the food labeling device taken on the line 8-8 of FIG. 7;

FIG. 9, a front elevational view of a rear housing half of the food labeling device taken on the line 9-9 of FIG. 7;

FIG. 10, a perspective view of a support frame of a printing device of the food labeling device;

FIG. 11, an elevational view of a support frame of the food labeling device taken on the line 11-11 of FIG. 10;

FIG. 12, a perspective view of a support frame of a printing device of the food labeling device; and

FIG. 13, a diagrammatic view of a controller of the food labeling device which includes a control circuit mounted on a circuit board.

### DETAILED DESCRIPTION OF THE ILLUSTRATED EMBODIMENTS

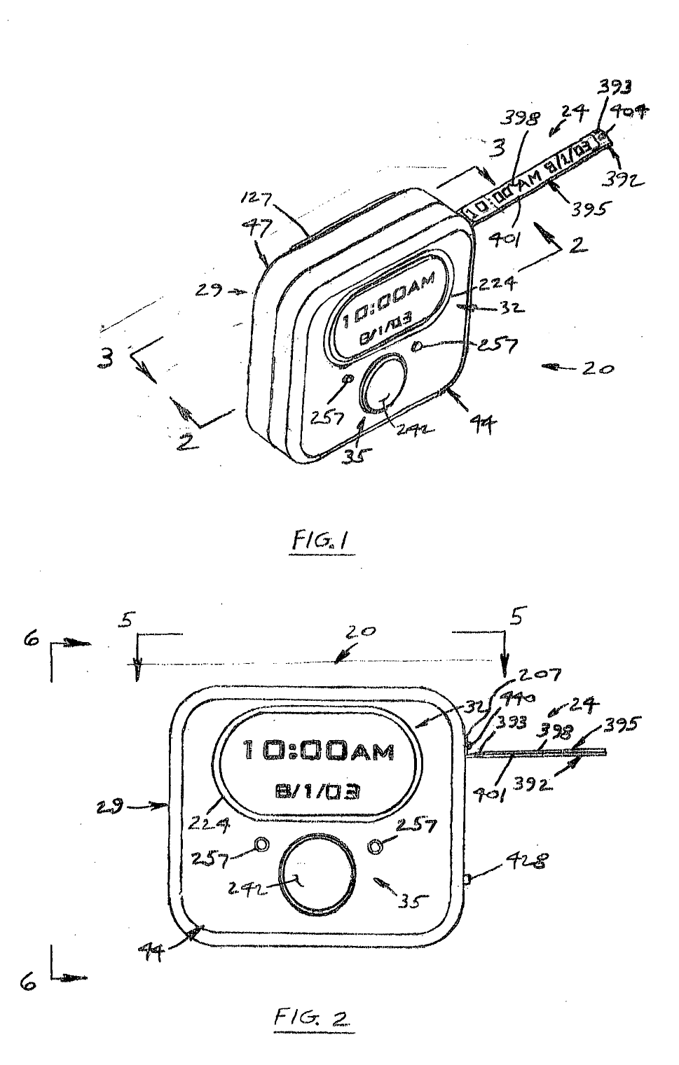

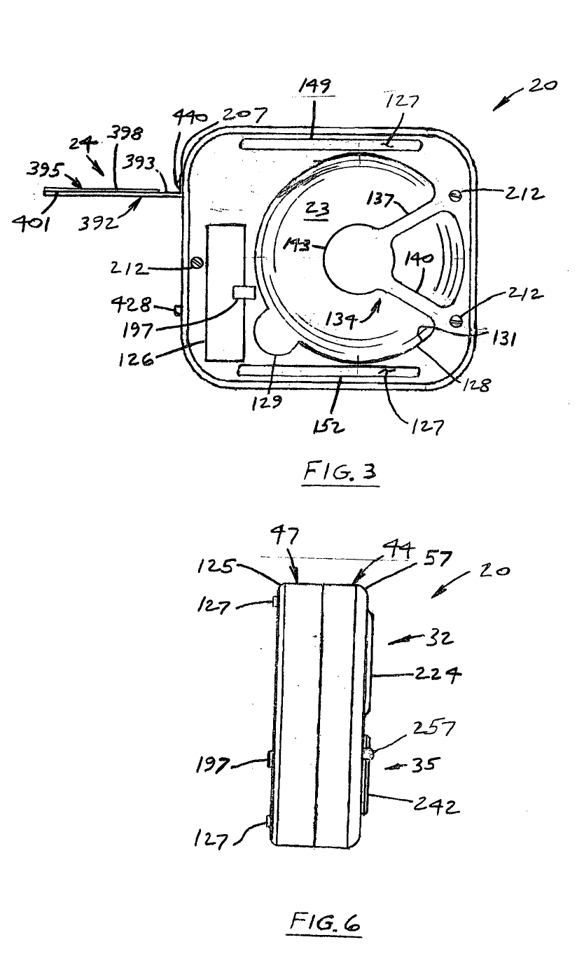

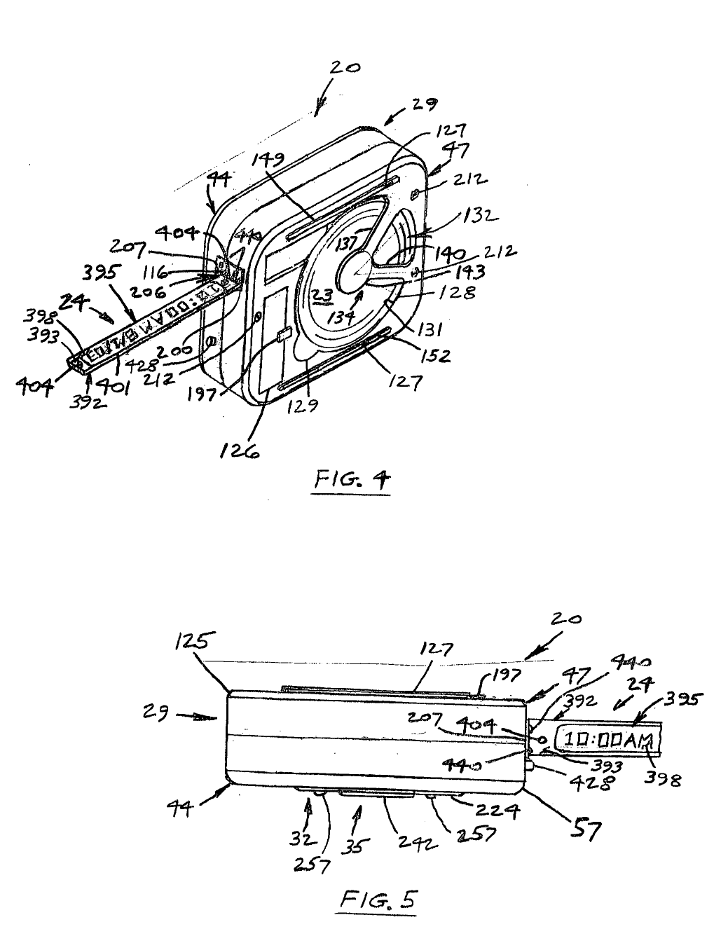

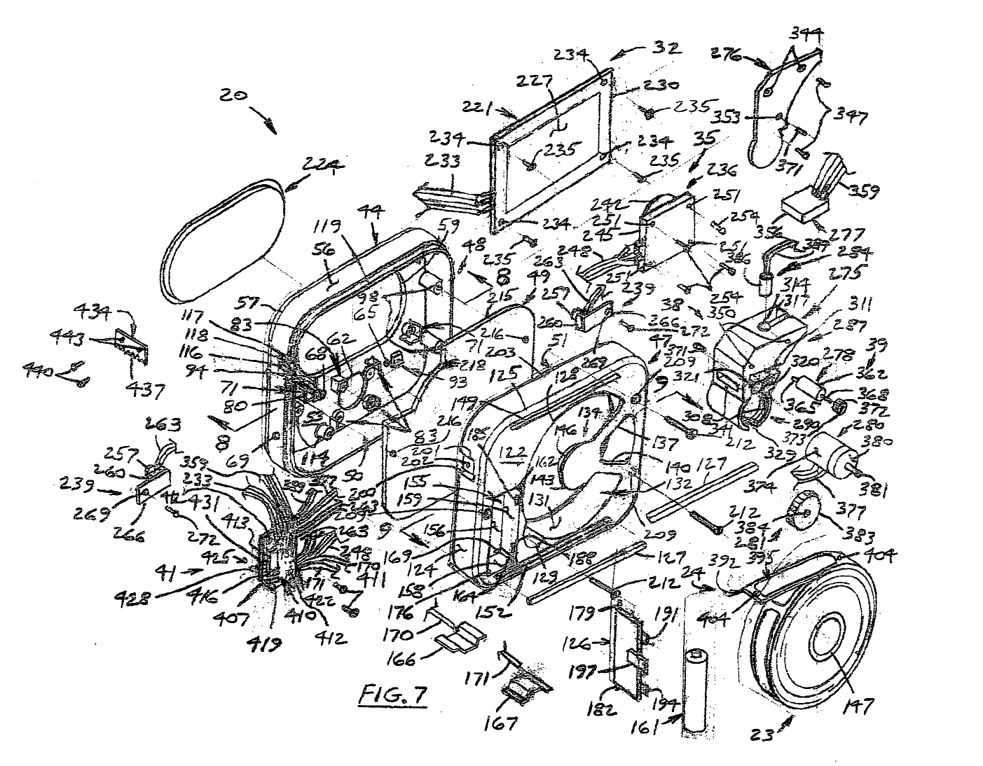

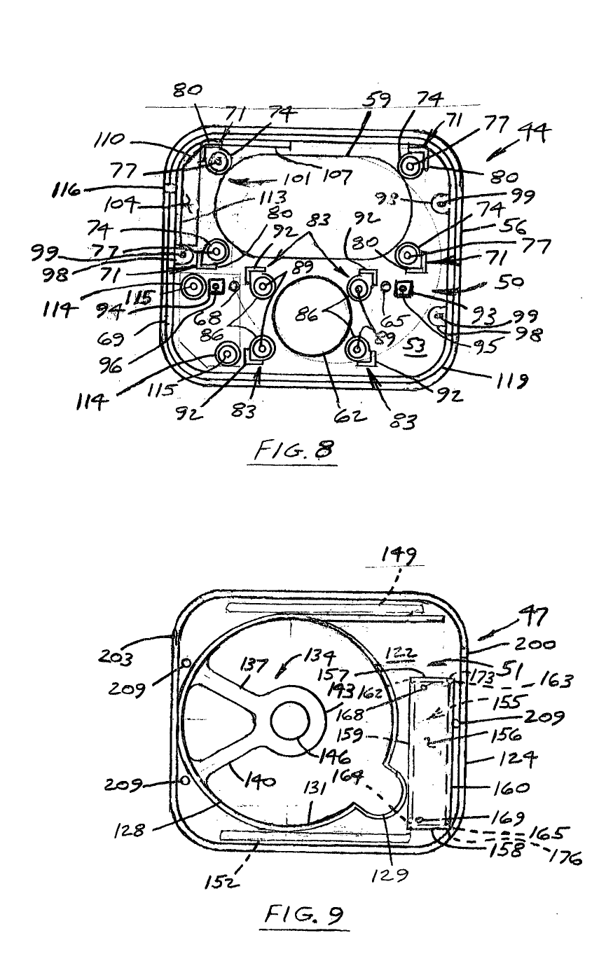

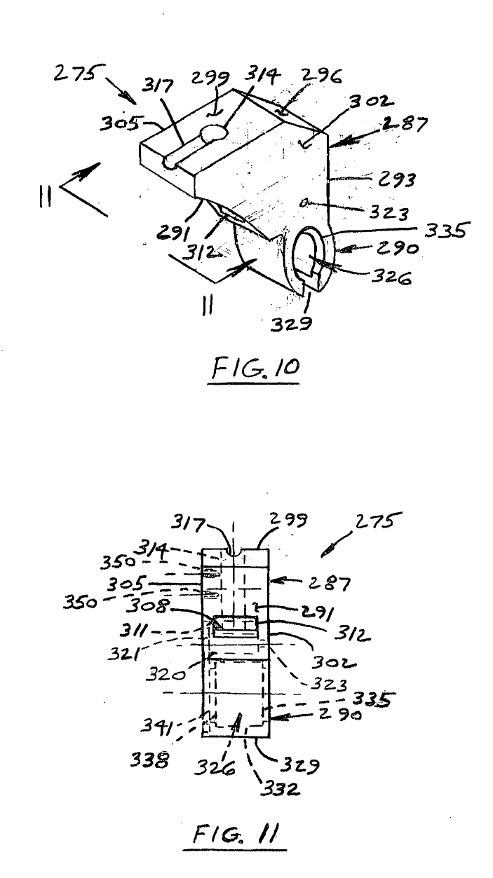

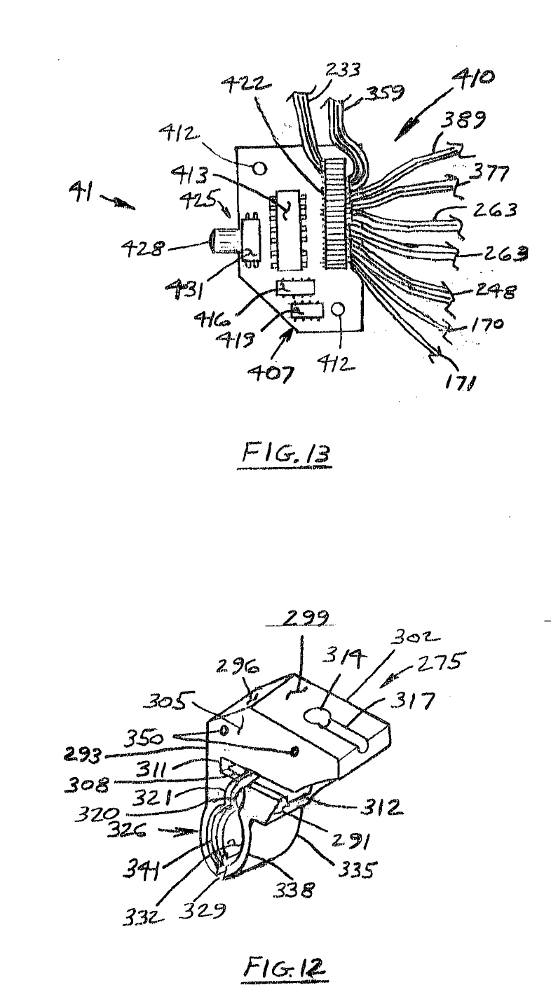

Referring to FIG. 1, therein is shown an exemplary food labeling device in accordance with the present invention, designated generally at 20, used with a label roll 23. The food labeling device is adapted for magnetic attachment to the ferrous metal door or cabinet of a conventional refrigerator or freezer (not shown). The food labeling device 20 is battery-powered for printing current time and/or date information or a future expiration time and/or date information on a label strip 24 of label roll 23 for adhesive attachment to food items (not shown).

The food labeling device 20 includes a housing 29 with which a plurality of component devices are associated including a display device 32, a control input assembly 35, a printing device 38, a transport device 39, and a controller 41.

The housing 29 is of such size as to be held in-hand and includes respective front and rear portions comprising front and rear housing halves 44 and 47 which interconnect to define an interior chamber 48 to receive the label roll 23 therewithin. The display device 32, the control input assembly 35, the printing device 38, the transport device 39, and the controller 41 are also disposed within housing 29. A center plate 49 divides the interior chamber into respective front and rear interior sub-chambers 50 and 51.

The front housing half 44 is typically molded from plastic and has a front wall 53 and a peripheral half wall 56 which extends rearwardly therefrom at a rounded peripheral edge 57. The display device 32 is viewable through a display hole 59 of an oval shape through the front wall 53, input device holes including an actuator switch hole 62 and a pair of set switch holes 65 and 68, and a power switch hole 69 extend through the front wall 53. A plurality of display corner supports 71 extend rearwardly from front wall 53 about display hole 59 and include respective cylindrical stand-offs 74 with center bores 77, and respective centering angles 80 which extend further from front wall 53 than stand-offs 74. A plurality of actuator switch corner supports 83 extend rearwardly from front wall 53 about actuator switch hole 62 and include respective cylindrical stand-offs 86 with center bores 89, and respective centering angles 92 which extend further from front wall 53 than stand-offs 86. A pair of rectangular set switch stand-offs 93 and 94 extend rearwardly from front wall 53 respectively adjacent set switch holes 65 and 68. The stand-offs 93 and 94 have respective center bores 95 and 96. A plurality of center plate support posts 98 extend rearwardly from front wall 53 and inwardly from peripheral halfwall 56 having respective bores 99. A printing device support 101 extends rearwardly from front wall 53 and inwardly from peripheral half wall 56. The printing device support 101 includes a floor 104, and respective top, angled, and side centering walls 107, 110, and 113. A pair of circuit board stand-offs 114 extend rearwardly from front wall 53 and include respective center bores 115. The peripheral half wall 56 has a label outlet half-slot 116 adjacent printing device support 101 with a recess 117 disposed thereabove. A cutter mounting hole 118 extends through the peripheral half wall 56 at recess 117. The peripheral half wall 56 has a stepped peripheral edge 119 for mating with rear housing half 47 in an overlapping manner.

The rear housing half 47 is typically molded from plastic and has a rear wall 122, a peripheral half wall 124 which extends forwardly therefrom at a rounded peripheral edge 125, a rectangular battery door 126 made of plastic, and a pair of mounting devices comprising elongate magnets 127 of generally rectangular cross-section. A label roll receiving hole 128 substantially circular in shape sized to for insertion of the label roll 23 into the interior chamber 48 includes a finger receiving portion 129 which extends radially therefrom adapted to facilitate removal of the label roll 23 from the interior chamber 48. The label roll receiving hole 128 with finger receiving portion 129 is defined by an interior wall 131 which extends forwardly from the rear wall 122 to define a label roll receiving chamber 132 of the interior chamber 48. The rear housing half 47 has a label roll support 134 adapted for positioning and rotatably supporting the label roll 23 within the label roll receiving chamber 132. The label roll support 134 includes a pair of resiliently flexible arms 137 and 140 which extend inwardly into label roll receiving hole 128 from and coplanar with the rear wall 122 of rear housing half 47 converging on and terminating at a central disk 143. A centering post 146 extends forwardly from central disk 143 to fit within a tubular core 147 of the label roll 23 to center the roll of thermal labels. Respective upper and lower magnet retaining grooves 149 and 152 are disposed in rear wall 122 for receiving respective of the magnets 127 which are adhesively affixed therein and adapted for removably magnetically mounting the food labeling device 20 to mounting surfaces (not shown) made of ferrous metal such as an upright refrigerator/freezer.

The rear housing half 47 includes a battery compartment 155 within the interior chamber 48 defined by a backing wall 156, a top wall 157, a bottom wall 158, a left side wall 159, and a right side wall 160. An electrical source or portable electrical storage device in the form of a battery 161 is removably insertable into the battery compartment 155 such as a conventional A23 sized Energizer™ twelve volt battery which powers the display device 32, the printing device 38, the transport device 39, and the controller 41. The battery 161 is compact enough to fit within the housing 29 yet of sufficient electrical power to operate the food labeling device 20 on the intermittent weekly basis when food products are added to the refrigerator or freezer such as upon return from weekly shopping trips. The battery 161 may be of a rechargeable nickel-cadmium type which is charged using a conventional battery charger (not shown) having an electrical cable which plugs into a charging socket (not shown) of the food labeling device 20. Alternatively, the battery 161 may be removed from battery compartment 155 and placed in a battery charger. The side walls 159 and 160 include respective upper slots 162 and 163, and lower slots 164 and 165 for receiving respective positive and negative battery contact strips 166 and 167 of rear housing half 47 made of spring steel. The backing wall 156 includes respective top and bottom wire exit holes 168 and 169 to pass respective insulated positive and negative electrical wires 170 and 171 affixed respectively to the positive and negative battery contact strips 166 and 167. The top wall 157 and bottom wall 158 have respective upper and lower pivot holes 173 and 176 to receive respective vertically disposed upper and lower hinge posts 179 and 182 of battery door 126. The left side wall 159 has a pair of tab receiving slots 185 and 188 to selectively engage respective retaining tabs 191 and 194 which keep the battery door 126 in a closed position. A finger engaging tab 197 of battery door 126 allows easy opening thereof to change the battery. The peripheral half wall 124 has a label outlet half-slot 200 adjacent the top wall 157 with a recess 201 disposed thereabove. A cutter mounting hole 202 extends through the peripheral half wall 124 at recess 201. The peripheral half wall 124 has a peripheral edge 203 which closely engages the stepped edge 119 of peripheral half wall 56 in the overlapping manner such the peripheral half walls 56 and 124 closely fit together at the peripheral edges 119 and 203. The label outlet half-slots 116 and 200 fit together to form a label outlet slot 206, and the recesses 117 and 201 form a blade receiving recess 207. A plurality of countersunk clearance holes 209 extend through rear wall 122 in corresponding position to bores 99 of support posts 98 for receiving respective flat head screws 212 to retain front and rear housing halves 44 and 47 together. The label strip 24 is passable outwardly from within the housing 29 through the label outlet slot 206 extending through the housing 29.

The center plate 49 has an outer periphery 215 which closely fits within the peripheral half wall 56 of front housing half 44. A plurality of clearance holes 216 extend through center plate 49 in corresponding position to bores 99 of support posts 98 for passing respective of the flat head screws 212 which retain front and rear housing halves 44 and 47 together. Center plate 49 has a printing device cutout 218 for accommodating the printing device 38.

The display device 32 is associated with the housing 29 and adapted for receiving the control signals from the controller 41 and displaying the time/date information for the user to view. The display device 32 typically comprises a liquid crystal display (LCD) 221 and a transparent protector plate 224 disposed over the display 221. The display 221 has a conventional LCD screen 227 peripherally contained within a mounting frame 230. An insulated conductive wire strip 233 from the LCD screen 227 extends outwardly from mounting frame 230 to the controller 41. The mounting frame 230 is sized to be closely received between the centering angles 80 of display corner supports 71. A plurality of plurality of mounting holes 234 extend through mounting frame 230 in corresponding position to bores 77 of stand-offs 74 for receiving respective round head screws 235 to retain display 221 to front housing half 44.

The control input assembly 35 is associated with the housing 29 and includes input devices associated with the housing 29 adapted for a user to operate the controller 41 including an actuator switch 236 for submitting the request for the time/date information to initiate label printing, and a pair of time/date set switches 239 for setting the time/date information of the controller 41, all of a conventional push button on/off type. The actuator switch 236 and time/date set switches 239 are accessible by the user through respective of the input device holes including actuator switch hole 62 and set switch holes 65 and 68 through the front housing half 44. The actuator switch 236 has a push button 242 which extends from a housing 245. An insulated conductive wire strip 248 extends outwardly from housing 245 to the controller 41. The housing 245 is sized to be closely received between the centering angles 92 of actuator switch corner supports 83. A plurality of mounting holes 251 extend through housing 245 in corresponding position to bores 89 of stand-offs 86 for receiving respective round head screws 254 to retain actuator switch 236 to front housing half 44 with push button 242 extending through actuator switch hole 62. The set switches 239 have respective push buttons 257 which extend from a housing 260. Respective insulated conductive wire strips 263 extend outwardly from housings 260 to the controller 41. The housings 260 include respective mounting plates 266 each having a mounting hole 269 in corresponding position to bores 95 and 96 of stand-offs 93 and 94 for receiving respective round head screws 272 to retain set switches 239 to front housing half 44 with push buttons 257 extending through respective of the set switch holes 65 and 68.

The printing device 38 is associated with the housing 29 and adapted for receiving the control signals from the controller 41 and imprinting the time/date information on the label strip 24 passing thereby from the label roll 23. The printing device 38 comprises a thermal printing device for printing on label strip 24 which includes a support frame 275 adapted to receive the label strip 24 therethrough, a retaining plate 276, a thermal printing head 277 fixedly mounted to the support frame 275, the retaining plate 276, and a cylindrical platen 278 rotationally mounted to the support frame 275 closely adjacent the printing head 277 to frictionally engage the label strip 24.

The transport device 39 is built-into the printing device 38 which is associated with the housing 29 and adapted for receiving the control signals from the controller 41 and advancing the label strip 24 in a coordinated manner with the printing device 38 past the printing head 277 to print the time/date information on the label strip 24. The transport device 39 includes a drive motor 280 mounted to the support frame 275 and operably connected to the platen 278 to receive the control signals from the controller 41 and rotate the platen 278 in the coordinated manner with printing of the printing head 277. The transport device 39 further includes a gear assembly 281, and a position sensor 284.

The support frame 275 is typically die-cast from metal or molded from heat resistant plastic and includes a contoured body 287 and a clip 290. The body 287 has a concave inside surface 291 to clear the label roll 23, a flat outside surface 293, a flat angled surface 296, a flat top surface 299, and a pair of flat side surfaces 302 and 305. A label passing slot 308 of rectangular cross-section extends longitudinally from the inside surface 291 through body 287 to the outside surface 293 through which the label strip 24 feeds from the label roll 23. A printing head slot 311 of rectangular cross-section extends transversely from side surface 302 most of the way through body 287 stopping short of the opposite side surface 305 to closely receive the printing head 277. A label input end 312 is flared to better receive the label strip 24 from the label roll 23 as it unrolls and becomes smaller in size. A sensor bore 314 is vertically disposed, extending from top surface 299 through to the label passing slot 308. A wire receiving slot 317 in top surface 299 connects the sensor bore 314 to the inside surface 291. A platen bore 320 extends transversely from side surface 302 most of the way through body 287 stopping short of the opposite side surface 305 to receive the platen 278. A gear clearance bore 321 is disposed coaxially with platen bore 320. A bearing hole 323 extends coaxially with platen bore 320 through to side surface 305. A motor bore 326 extends transversely from side surface 302 through clip 290 to the opposite side surface 305 with a longitudinal slit 329. An inner portion 332 of motor bore 326 is of a larger diameter to snugly receive the drive motor 280, and defining respective annular shoulders 335 and 338 to longitudinally retain drive motor 280. A gear clearance bore 341 is disposed coaxially with motor bore 326.

The retaining plate 276 is typically made of metal or plastic and is of matching outer profile to support frame 275, and includes a pair of countersunk clearance holes 344. Retaining plate 276 is mounted to support frame 275 using a pair of flat head screws 347 which extend through holes 344 and engage respective threaded holes 350 in body 287. A bearing hole 353 is coaxial with platen bore 320 when retaining plate 276 is mounted to support frame 275.

The thermal printing head 277 includes a housing 356 and an insulated conductive wire strip 359 which extends outwardly therefrom connected to the controller 41. The internal workings of the printing head 277 are conventional and thus is not further explained. The printing head 277 slip fits within the printing head slot 311 of support frame 275 and is retained therein by abutting the retaining plate 276.

The platen 278 is of conventional design for thermal printing devices, including a cylindrical body 362 from which respective short and long stub shafts 365 and 368 coaxially extend. The platen 278 slip fits within the platen bore 320 of support frame 275 with the short stub shaft 365 rotationally supported in a bearing or bushing 371 pressfit into the bearing hole 323 of support frame 275. A small gear 372 of gear assembly 281 press-fits onto the long stub shaft 368 through a bore 373 with the end thereof extending therethrough. Stub shaft 368 is rotationally supported in another of bushings 371 pressfit into the bearing hole 353 of retaining plate 276, stub shaft 368 being retained thereby.

The drive motor 280 typically includes an electric stepping motor 374 with an insulated conductive wire strip 377 which extends outwardly therefrom connected to the controller 41. The stepping motor 374 drives a gear box 380 to set a desired rotational gearing with the platen 278, with a rotary power output shaft 381 which extends therefrom. The drive motor 280 is operably connected to the platen 278 through a plurality of gears including a large gear 383 of gear assembly 281 pressfits onto output shaft 381 through a bore 384 and meshes with the small gear 372 when drive motor 280 is snap-fit into clip 290.

The position sensor 284 is adapted to sense positioning of the label strip 24 and includes a cylindrical housing 386 and an insulated conductive wire strip 389 which extends outwardly therefrom connected to the controller 41. The position sensor 284 detects a plurality of markers on the label strip 24 disposed at substantially equally spaced positions as subsequently explained.

The label roll 23 comprised of the label strip 24 includes a backing strip 392 with a release surface 393 coated with a separating agent (not shown) to which a plurality of individual adhesive labels 395. The labels include a thermal printable layer 398 and an adhesive backing 401 which is removably adhered to the backing strip 392 in a linear spaced manner. A plurality of markers in the form of spaced perforations 404 through backing strip 392 are individually disposed between the labels 395 along the label strip 24 disposed at substantially equally spaced positions for determining position of the labels 395 relative to the printing head 277 and detectable by the position sensor 284.

The position sensor 284 is adapted to sense the positioning of label strip 24 by detecting a plurality of markers on the label strip 24 disposed at substantially equally spaced positions such as the perforations 404 or a printed indicia (not shown) for determining position of the individual labels 395 relative to the printing head 277 of printing device 38. Exemplary position sensors 284 include those of a light emitting/detecting type which emits and detects reflected light from the label strip 24 or perforations 404, a mechanical type which physically touches the label strip 24 to detect the perforations 404, or other suitable type to sense the position of label strip 24.

The controller 41 is associated with the housing 29 and adapted for computing and outputting the time/date information in the form of control signals upon receipt of a request therefor. The controller 41 includes a circuit board 407 mounted to the stand-offs 114 using a pair of screws 411 which extend through respective holes 412 through circuit board 407. A control circuit 410 is mounted comprising a processor 413 adapted for executing sequences of program instructions with an integral or separate clock device (not shown) such as a real-time clock for computing the current time/date and future expiration time/date information. The processor 413 is responsive to the signals from the input devices including actuator switch 236 and set switches 239 of control input assembly 35 for operation thereof. A program memory device in the form of a read only memory (ROM) device 416 is provided for storing the sequences of program instructions. The program memory device may comprise a programmable read only memory (PROM) device (not shown) if so desired to allow flexibility in programming thereof which contains any required software for operating the food labeling device 20. A data memory device in the form of a random access memory (RAM) device 419 is provided for temporarily storing data including the time/date information from the processor 413 and data from the ROM device 416 during setting of the controller and printing operations, the data being sent to the display device 32 and to the printing device 38 for controlling operation thereof. An electrical bus 422 provides connection points to tie together the components of the control circuit 410 for communication therebetween. A power switch 425 of the push button on/off type is provided to control electrical power from the battery 161. Power switch 425 is mounted directly to circuit board 407 and includes a push button 428 and a base 431.

The housing 29 includes a cutting blade 434 mounted thereto typically made of steel or plastic disposed within recess 207 with a serrated cutting edge 437 disposed immediately adjacent the label outlet slot 206. The cutting blade 434 is mounted to housing 29 using a pair of screws 440 which extend through respective clearance holes 443 of cutting blade 434 and thread into cutter mounting holes 118 and 202 of front and rear housing halves 44 and 47.

The food labeling device 20 is used primarily to label perishable foods in refrigerators or freezers with labels 395 that stick to plastic containers, Tupperware™, glass, cardboard, tinfoil, paper, etc. containing the food products. The food labeling device 20 may also be used to mark the date purchased or opened on other items. This includes labeling anything date sensitive such as mailing bills, dating paid bills, or anything for filing, dating photographs, and the like.

The food labeling device 20 is readied for use by first grasping the tab 197 and pulling outwardly on the battery door 126 until the retaining tabs 191 and 194 unseat from the tab receiving slots 185 and 188 of rear housing half 47 such that the battery door 126 pivots open about upper and lower hinge posts 179 and 182. The battery 161 is inserted into the battery compartment 155 between the battery contact strips 166 and 167 to supply electrical power to the display device 32, the printing device 38, the transport device 39, and the controller 41. The battery door 126 is then closed to retain battery 161 in the battery compartment 155. Next, the label roll 23 is loaded into the label roll receiving chamber 132 by rearwardly flexing the label roll support 134 slightly to allow entrance thereof. The centering post 146 is positioned within the tubular core 147 of the label roll 23. New label rolls 23 may be loaded in similar manner upon depletion of the initial label roll 23 by again rearwardly flexing the label roll support 134 slightly and removing the tubular core 147. The label strip 24 is moved past the position sensor 284 and into the space between the printing head 277 and the platen 278, which space is less than the thickness of the label strip 24 so as to provide frictional engagement therewith. The platen 278 may include an external coating (not shown) of resilient, heat-resistant material and/or the printing head 277 and/or the platen 278 may be resiliently mounted to provide flexing for better gripping of the areas of the backing strip 392 between the labels 395. The push button 242 is then depressed and released triggering the controller 41 to drive stepping motor 374 to drive gear box 380, gear 383, gear 372, and platen 278 to frictionally drive label strip 24 outwardly through the label passing slot 308. When the position sensor 284 detects one of the perforations 404 through backing strip 392, the controller 41 signals the stepping motor 374 to stop. Finally, the current time and date are input to set the controller 41 by sequentially pushing and/or holding the push buttons 257 in a similar manner to setting an electronic watch. The food labeling device 20 is now ready for use with the current time/date information continuously displayed on the display device 32. Alternatively, the food labeling device 20 may be configured to display the time/date information only upon depressing and releasing the push button 242.

The food labeling device 20 is used to print the current time/date information on the labels 395 by depressing and releasing the push button 242 which causes the current time/date information shown on the display device 32 to be sent to the printing device 38. The printing head 277 heats up and prints the time/date information on the label 395 while the controller 41 signals the stepping motor 374 to rotate platen 278 to advance the label strip 24 in coordinated stepwise manner with the printing head 277 at a rate that advances and sequentially positions the label strip 24 with label 395 to permit imprinting thereon of the current time/date information by the printing head 277. When printing completed, the controller 41 signals the stepping motor 374 to rotate platen 278 in stepped rotation action to advance the label strip 24 until the position sensor 284 detects the next perforation 404. The printed label 395 now extends completely out of the housing 29 through the label outlet slot 206 with the cutting blade 434 disposed between adjacent labels 395. Pulling the label strip 24 upwardly causes the cutting edge 437 to cut the backing strip 392 and the printed label 395 may then be removed from the severed backing strip 392 and applied to the container in which the food product is contained.

The food labeling device 20 may be configured to additionally or alternatively print a future expiration time/date by which time the food product should be used or disposed of. This is easier for the user than needing to mentally compute the expiration date at a later time based on the printed labels 395 and the shelf life of the particular food product. The food labeling device 20 is the same as explained above, except that an expiration period is input to the controller 41 using the existing push buttons 257 or by having additional push buttons 257 specifying predetermined expiration periods such as one week, two weeks, three weeks, one month, six weeks, two months, etc. based on the type of food product. These would be labeled on the front housing half 44 by length of expiration period and/or the type of food product such as milk, cheese, fish, steak, etc. The controller 41 would be configured to recognize the additional commands specifying expiration period from the push buttons 257 and any additional ones. Once the expiration period is entered for the particular food product, the push button 242 is depressed and released, causing printing as described above, but of the expiration time/date instead. The food labeling device 20 may also be configured to print both the current and the expiration time/date information and other related information.

Many variations to the food labeling device of the present invention are possible while staying within the same inventive concept, including but not limited to the following examples. For example, alternate printing devices using small non-thermal type printing heads may be used in the food labeling device. Various materials and processes may be used for constructing the components of the food labeling device. While the label roll is shown entirely contained within the housing, the housing may be adapted to partially contain the label roll or the label roll be mounted completely externally thereof. The label rolls may even be contained in refillable cartridges which mount similarly to the label rolls internally, externally, or partially internally of the housing. The housing may include an adhesive backing instead of or in addition to the magnets so the food labeling device may be mounted to the refrigerator/freezer or to non-ferrous surfaces. Alignment marks may be printed on the label strip to facilitate alignment of the adhesive labels relative to the printing head such as if the position sensor is not used. A pin may be disposed at the outlet slot of the housing to bend the backing strip downwardly to automatically separate the labels from the backing strip as the label strip discharges from the housing through the label outlet slot. The label strip may have a continuous label adhesively secured to the backing strip if desired rather than a plurality of individual labels. This configuration allows the position sensor and perforations to be eliminated since the print head may print anywhere on the continuous label without having non-printable spaces of the backing strip between individual labels. The controller is then configured to print on the continuous label in predetermined lengths and advance the label strip so the printing is past the serrated blade for cutting off.

Whereas this invention is here illustrated and described with reference to embodiments thereof presently contemplated as the best mode of carrying out such invention in actual practice, it is to be understood that various changes may be made in adapting the invention to different embodiments without departing from the broader inventive concepts disclosed herein and comprehended by the claims that follow.

1. A food labeling device powerable by an electrical source for printing time/date information on a label strip with adhesive backing for attachment to food items which is removably adhered to a backing strip formed as a label roll, comprising:
a housing adapted for receiving the label roll;
a controller associated with said housing adapted for computing and outputting the time/date information in the form of control signals upon receipt of a request therefor;
at least one input device associated with said housing adapted for a user to operate said controller including setting the time/date information and for submitting the request therefor;
a display device associated with said housing adapted for receiving the control signals from said controller and displaying the time/date information for the user to view;
a printing device associated with said housing adapted for receiving the control signals from said controller and imprinting the time/date information on the label strip passing thereby from the label roll;
a transport device associated with said housing adapted for receiving the control signals from said controller and advancing the label strip in a coordinated manner with printing of the time/date information by said printing device on the label strip; and
wherein said controller, input device, display device, printing device, and transport device are powered by the electrical source.

2. The food labeling device according to claim 1, wherein the housing is of such size as to be held in-hand and defines an interior chamber in which the controller, the electrical source, each input device, the display device, the printing device, and the transport device are disposed, said display device being viewable through a display hole through said housing, each input device being accessible by the user through respective input device holes through said housing, and the label strip being passable outwardly from within said housing through a label outlet slot extending through said housing.

3. The food labeling device according to claim 2, wherein the housing includes a battery compartment within the interior chamber into which the electrical source in the form of a portable electrical storage device is removably insertable.

4. The food labeling device according to claim 2, wherein the housing comprises respective front and rear housing halves which interconnect to define an interior chamber, said front housing half having a front wall and a peripheral half wall which extends rearwardly therefrom, and said rear housing half having a rear wall and a peripheral half wall which extends forwardly therefrom, said peripheral half walls fitting together at respective edges.

5. The food labeling device according to claim 2, wherein a transparent protector plate is disposed over the display device.

6. The food labeling device according to claim 1, wherein the controller includes a processor adapted for executing sequences of program instructions with a clock device for computing the time/date information, said processor being responsive to the signals from the input device for operation thereof, at least one program memory device for storing the sequences of program instructions, at least one data memory device for temporarily storing data including the time/date information from said processor and data from said program memory device, said data being sent to the display device and to the printing device for controlling operation thereof.

7. The food labeling device according to claim 6, wherein the program memory device comprises at least one device chosen from the group consisting of a read only memory (ROM) device and a programmable read only memory (PROM) device, and the data memory comprises at least one random access memory (RAM) device.

8. The food labeling device according to claim 1, wherein the display device comprises a liquid crystal display.

9. The food labeling device according to claim 1, wherein the housing includes at least one mounting device affixed to a rear portion of said housing adapted for mounting the food labeling device to a mounting surface.

10. The food labeling device according to claim 9, wherein the mounting devices comprise magnets affixed adapted for removably magnetically mounting the food labeling device to mounting surfaces made of ferrous metal.

11. The food labeling device according to claim 1, wherein the housing is adapted to receive the label roll within the interior chamber.

12. The food labeling device according to claim 11, wherein a rear portion of the housing includes a label roll receiving hole sized for insertion of the label roll into said interior chamber, and said housing having a label roll support adapted for positioning and rotatably supporting the label roll within the interior chamber.

13. The food labeling device according to claim 12, wherein the label roll receiving hole is substantially circular in shape with a finger receiving portion which extends radially therefrom adapted to facilitate removal of the label roll from the interior chamber.

14. The food labeling device according to claim 12, wherein the label roll receiving hole is defined by an interior wall which extends forwardly from the rear portion to define a label roll receiving chamber of the interior chamber.

15. The food labeling device according to claim 12, wherein the label roll support includes at least one resiliently flexible arm which extends inwardly into the label roll receiving hole from the rear portion of the housing terminating at a central disk with a centering post which extends forwardly therefrom to fit within a tubular core of the label roll.

16. The food labeling device according to claim 15, wherein the label roll support includes a pair of resiliently flexible arms which extend inwardly into the label roll receiving hole from the rear portion of the housing and converge on the central disk.

17. The food labeling device according to claim 1, wherein input devices include an actuator switch to initiate label printing and at least one time/date set switch for setting the time/date information of the controller.

18. The food labeling device according to claim 17, wherein the actuator switch and time/date set switches are of a push button type.

19. The food labeling device according to claim 17, wherein one input device comprises a power switch.

20. The food labeling device according to claim 1, wherein the printing device comprises a thermal printing device for printing on thermal printable label strips.

21. The food labeling device according to claim 20, wherein the thermal printing device includes a support frame adapted to receive the label strip therethrough, a thermal printing head fixedly mounted to said support frame, and a cylindrical platen rotationally mounted to said support frame closely adjacent said thermal printing head to frictionally engage the label strip.

22. The food labeling device according to claim 21, wherein the transport device includes a drive motor mounted to the support frame and operably connected to the platen adapted to receive the control signals from the controller and rotate said platen in the coordinated manner with printing by said thermal printing head on the label strip.

23. The food labeling device according to claim 22, wherein the drive motor is operably connected to the platen through a plurality of gears.

24. The food labeling device according to claim 22, wherein the drive motor comprises an electric stepping motor.

25. The food labeling device according to claim 24, wherein the drive motor further comprises a gear box driven by the stepping motor which drives the gears.

26. The food labeling device according to claim 1, further comprising:
a position sensor adapted to sense positioning of the label strip by detecting a plurality of markers on the label strip disposed at substantially equally spaced positions for determining position of the individual labels relative to the printing device; and
wherein the controller is adapted for printing label strips comprised of a plurality of individual labels with adhesive backing which are removably adhered in a linear spaced manner to the backing strip.

27. The food labeling device according to claim 26, wherein the position sensor is adapted to detect markers of a type chosen from the group consisting of perforations and printed indicia.

28. The food labeling device according to claim 1, wherein the housing includes a cutting blade mounted thereto having a cutting edge disposed immediately adjacent the label outlet slot.

29. A food labeling device powerable by an electrical source for printing time/date information on a label strip with adhesive backing for attachment to food items which is removably adhered to a backing strip formed as a label roll, comprising:
a housing adapted for receiving the label roll;
a controller associated with said housing adapted for computing and outputting the time/date information in the form of control signals upon receipt of a request therefor;
at least one input device associated with said housing adapted for a user to operate said controller including setting the time/date information and for submitting the request therefor, said input devices including an actuator switch to initiate label printing and at least one time/date set switch for setting the time/date information of said controller;
a display device associated with said housing adapted for receiving the control signals from said controller and displaying the time/date information for the user to view;
a printing device associated with said housing adapted for receiving the control signals from said controller and imprinting the time/date information on the label strip passing thereby from the label roll;
a transport device associated with said housing adapted for receiving the control signals from said controller and advancing the label strip in a coordinated manner with printing of the time/date information by said printing device on the label strip; and
wherein said controller, input device, display device, printing device, and transport device are powered by the electrical source, said housing is of such size as to be held in-hand and defines an interior chamber in which said controller, said electrical source, each input device, said display device, said printing device, and said transport device are disposed, said display device being viewable through a display hole through said housing, each input device being accessible by the user through respective input device holes through said housing, and the label strip being passable outwardly from within said housing through a label outlet slot through said housing, said housing including a battery compartment within said interior chamber into which the electrical source in the form of a portable electrical storage device is removably insertable, said housing including at least one mounting device affixed to a rear portion of said housing adapted for mounting the foo labeling device to a mounting surface.

30. The food labeling device according to claim 29, wherein the display device comprises a liquid crystal display, the housing is adapted to receive the label roll within the interior chamber, and the printing device comprises a thermal printing device for printing on thermal printable label strips.

31. The food labeling device according to claim 30, wherein a rear portion of the housing includes a label roll receiving hole sized for insertion of the label roll into said interior chamber, and said housing having a label roll support adapted for positioning and rotatably supporting the label roll within the interior chamber, and said label roll support includes at least one resiliently flexible arm which extends inwardly into the label roll receiving hole from the rear portion of the housing terminating at a central disk with a centering post which extends forwardly therefrom to fit within a tubular core of the label roll.

32. The food labeling device according to claim 29, further comprising:
a position sensor adapted to sense positioning of the label roll by detecting a plurality of markers on the label strip disposed at substantially equally spaced positions for determining position of the individual labels relative to the printing device; and
wherein the controller is adapted for printing label strips comprised of a plurality of individual labels with adhesive backing which are removably adhered in a linear spaced manner to the backing strip and said position sensor is adapted to detect markers of a type chosen from the group consisting of perforations and printed indicia.

33. A food labeling device powerable by an electrical source for printing time/date information on a label strip with adhesive backing for attachment to food items which is removably adhered to a backing strip formed as a label roll, comprising:
a housing adapted for receiving the label roll;
a controller associated with said housing adapted for computing and outputting the time/date information in the form of control signals upon receipt of a request therefor;
at least one input device associated with said housing adapted for a user to operate said controller including setting the time/date information and for submitting the request therefor, said input devices including an actuator switch to initiate label printing and at least one time/date set switch for setting the time/date information of said controller;
a display device associated with said housing adapted for receiving the control signals from said controller and displaying the time/date information for the user to view;
a printing device associated with said housing adapted for receiving the control signals from said controller and imprinting the time/date information on the label strip passing thereby from the label roll, said printing device including a support frame adapted to receive the label strip therethrough, a printing head fixedly mounted to said support frame, and a cylindrical roller rotationally mounted to said support frame closely adjacent said printing head to frictionally engage the label strip;
a transport device associated with said housing adapted for receiving the control signals from said controller and advancing the label strip in a coordinated manner with printing of the time/date information by said printing device on the label strip, said transport device including a drive motor comprising an electric stepping motor mounted to said support frame and operably connected to said roller platen adapted to receive said control signals from said controller and rotate said roller in the coordinated manner with said printing head; and
wherein said controller, input device, display device, printing device, and transport device are powered by the electrical source.

34. The food labeling device according to claim 33, wherein the printing device comprises a thermal printing device for printing on thermal printable label strips.

35. The food labeling device according to claim 33, wherein the drive motor is operably connected to the platen through a plurality of gears, and said drive motor further comprises a gear box driven by the stepping motor which drives said gears.

36. The food labeling device according to claim 33, further comprising:
a position sensor adapted to sense positioning of the label strip by detecting a plurality of markers on the label strip disposed at substantially equally spaced positions for determining position of the individual labels relative to the printing device; and
wherein the controller is adapted for printing label strips comprised of a plurality of individual labels with adhesive backing which are removably adhered in a linear spaced manner to the backing strip and said position sensor is adapted to detect markers of a type chosen from the group consisting of perforations and printed indicia.
